(19) United States
(12) Patent Application Publication
(10) Pub. No.: US 2011/0280668 A1
(43) Pub. Date: Nov. 17, 2011

(54) Hang-Off Adapter for Offshore Riser Systems and Associated Methods

(75) Inventor: Greg Norwood, Houston, TX (US)

(73) Assignee: RN MOTION TECHNOLOGIES, Houston, TX (US)

(21) Appl. No.: 12/947,330

(22) Filed: Nov. 16, 2010

Related U.S. Application Data
(60) Provisional application No. 61/261,391, filed on Nov. 16, 2009.

(51) Int. Cl. E21B 17/01; F16L 3/16; F16L 3/00; E21B 19/09

(52) U.S. Cl. 405/224.4; 248/62

(57) ABSTRACT

Hang-off adapters for use in offshore riser systems are provided that seat in a tension ring while allowing for relative rotation between the tension ring and the riser. In one embodiment, the hang-off adapter may comprise a tension ring interface configured to engage an inner landing of a tension ring, the tension ring interface being in the shape of a ring.

### CROSS-REFERENCE TO RELATED APPLICATIONS

This application claims priority to U.S. Provisional Application No. 61/261,391, entitled “Hang-Off Adapter for Offshore Riser Systems and Associated Methods,” filed on Nov. 16, 2009, the entire disclosure of which is incorporated herein by reference.

### BACKGROUND

This invention relates to offshore riser systems and, more particularly, in one or more embodiments, to hang-off adapters for use in offshore riser systems that seat in a tension ring while allowing for relative rotation between the tension ring and the riser.

Risers are used in the development and recovery of natural resources, such as oil and gas, from deposits located offshore. In general, a riser is a string of pipe through which drilling, completion, production, workover, and other downhole operations may be conducted. The riser typically extends from the sea bottom to the surface with one end supported from a floating platform and the other end attached to the subsea wellhead. To prevent its collapse, the riser must be kept in tension. A tensioning system that may include hydraulic cylinders coupled to the riser by a tension ring may be used to place the riser in tension by pulling up on the riser. Because waves, ocean currents, and winds can cause movement of the floating platform to which the riser is coupled, the tensioning system should also allow for some movement. It is sometimes necessary to hang the riser off the tension ring so that particular downhole operations can be performed. For instance, hang off may be need when the apparatus holding the top of the riser is removed to provide access for running tools inside the riser or when equipment is installed on top of the riser.

When desired to hang the riser off in the tension ring, an adapter or other suitable device can be used to support the riser in the tension ring. One hang-off technique utilizes a split-bushing adapter seated in the landing of the tension ring. The split-bushing adapter supports the riser in the tension ring while allowing for relative rotation between the tension ring and the riser. However, there is no easy way to seat this adapter in the tension ring. Rather, the split-bushing adapter must be lowered manually into the tension ring. Installing this adapter is time consuming and places personnel in a hazardous position below the moonpool of a floating platform. Additionally, the adapter is not integral with the riser when landed in the tension ring.

### SUMMARY

An embodiment of the present invention provides a hang-off adapter configured for attachment to a riser. The hang-off adapter may comprise a tension ring interface configured to engage an inner landing of a tension ring. The tension ring interface being in the shape of a ring.

Another embodiment of the present invention provides a hang-off adapter. The hang-off adapter may comprise an inner body configured to couple the adapter to a riser. The inner body may comprise an upper end, a lower end, and a passageway extending through the inner body. The hang-off adapter may further comprise an inner housing that encloses at least a portion of the inner body. The hang-off adapter may further comprise a bearing configured to allow axial rotation of the inner body. The hang-off adapter may further comprise an outer housing enclosing at least a portion of the bearing. The hang-off adapter may further comprise a tension ring interface configured to engage an inner landing of the tension ring. The hang-off adapter may further comprise gusset plates connecting the outer housing and the tension ring interface.

Yet another embodiment of the present invention provides a method for hanging a riser off a tension ring. The method may comprise providing a hang-off adapter. The method may further comprise coupling the hang-off adapter to the riser. The method may further comprise seating a tension-ring interface of the hang-off adapter in a landing of the tension ring. The tension ring may be coupled to a vessel by way of a tensioning system. The method may further comprise releasing the weight of the riser so that the riser hangs off the tension ring, wherein riser is rotatable with respect to the tension ring.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. Although individual embodiments are discussed, the invention covers all combinations of all those embodiments. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a floating platform with a riser and tensioning system coupled thereto in accordance with one embodiment of the present invention.

FIG. 2 illustrates a floating platform with a riser and a wire-line tensioning system coupled thereto in accordance with one embodiment of the present invention.

FIG. 3 is a perspective view of a hang-off adapter in accordance with one embodiment of the present invention.

FIG. 4 is a top view of a hang-off adapter in accordance with one embodiment of the present invention.

FIG. 5 is a cross-sectional view of a hang-off adapter taken along line 5-5 of FIG. 4, in accordance with one embodiment of the present invention.

FIG. 6 is a cross-sectional view of a hang-off adapter seated in a tension ring in accordance with one embodiment of the present invention.

FIG. 7 is a cross-sectional view of a hang-off adapter seated in a tension ring in accordance with an alternative embodiment of the present invention.

FIG. 8 is a cross-sectional view of a hang-off adapter seated in a tension ring in accordance with an alternative embodiment of the present invention.

### DETAILED DESCRIPTION OF PREFERRED EMBODIMENTS

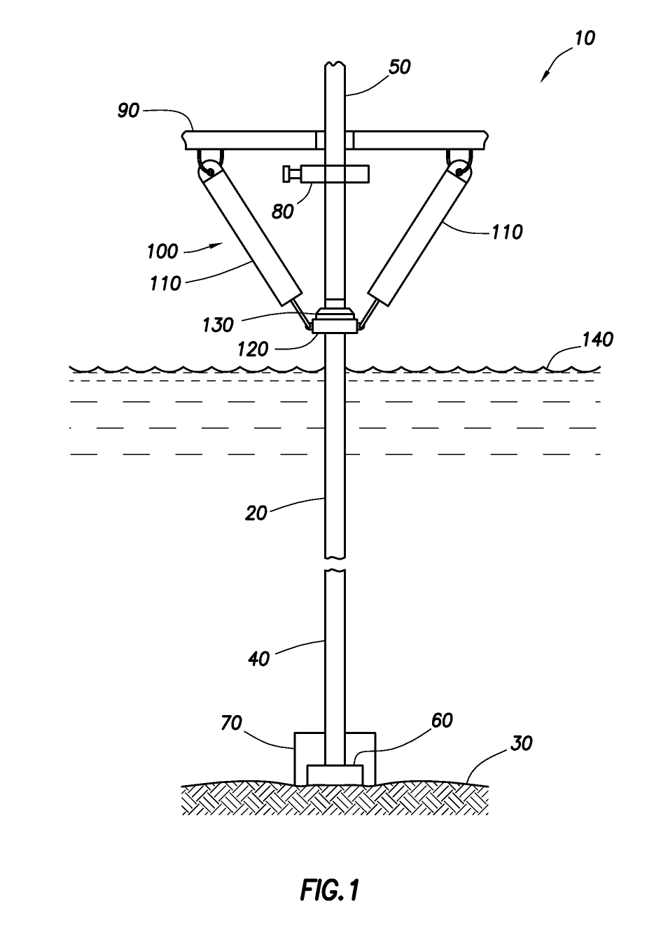

Referring now to FIG. 1, a floating platform 10 is illustrated in accordance with one embodiment of the present invention. The floating platform 10 may be used, for example, in the drilling, completion, production, or workover of oil and/or gas wells. The floating platform 10 may be, for example, a vessel (e.g., floating ship, semi-submersible platform, etc.) on which the drilling rig and production facilities may be placed. As illustrated, a riser 20 may extend from the sea floor 30 to the floating platform 10. The riser 20 has a lower end 40 and an upper end 50. The lower end 40 of the riser 20 may be connected to the subsea wellhead 60 with the upper end 50 of the riser 20 connected to a surface wellhead or christmas tree (not illustrated). A tie back/drilling connector 70 may also be coupled to the lower end 40 of the riser 20. The upper end 50 of the riser 20 may include a diverter 80 for preventing certain fluids from reaching the deck 90 (e.g., drill floor) of the floating platform 10. The upper end 50 of the riser 20 may be connected to the deck 90 by way of a tensioning system 100. The tensioning system 100 may include hydraulic cylinders 110 and a tension ring 120. As illustrated, the tension ring 120 may be above the surface 140 of the sea. In an embodiment (not illustrated), the tension ring 120 may be below the surface 140 of the sea. A hang-off adapter 130 coupled to the riser 20 may be seated in the tension ring 120. In the illustrated embodiment, the riser 20 is hung off the tension ring 120 via the hang-off adapter 130. In an embodiment (not illustrated), the tension ring 120 can be used when the riser 20 is not connected to the wellhead 60.

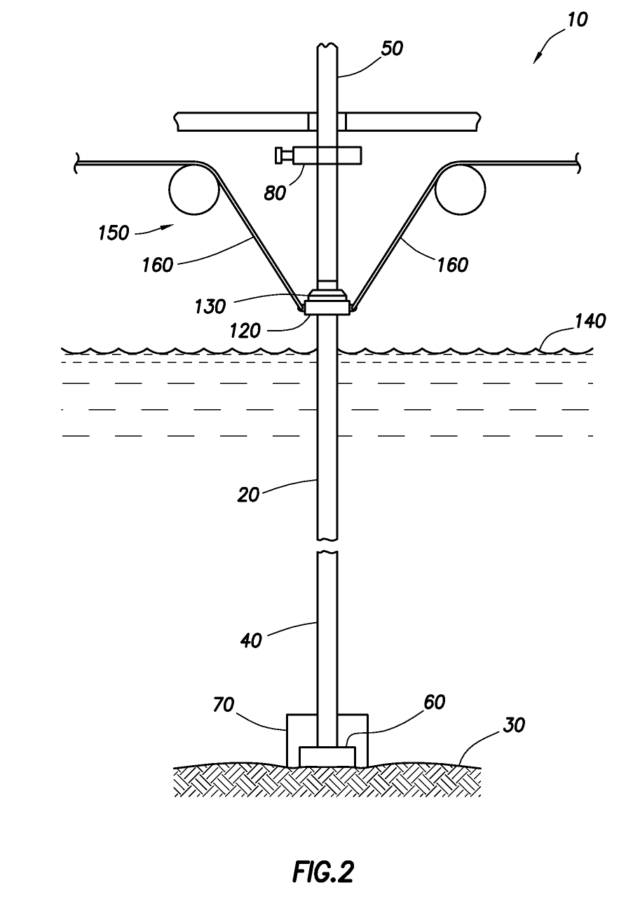

While the preceding discussion describes a tensioning system 100 with hydraulic cylinders 110, other tensioning systems may also be suitable for use in embodiments of the present invention. For example, FIG. 2 illustrates a wire-line tensioning system 150 that may be used in accordance with embodiments of the present invention. As illustrated, the wire-line tensioning system 150 may include wirelines 160 and a tension ring 120. A hang-off adapter 130 coupled to the riser 20 may be seated in the tension ring 120. In the illustrated embodiment, the riser 20 is hung off the tension ring 120 via the hang-off adapter 130.

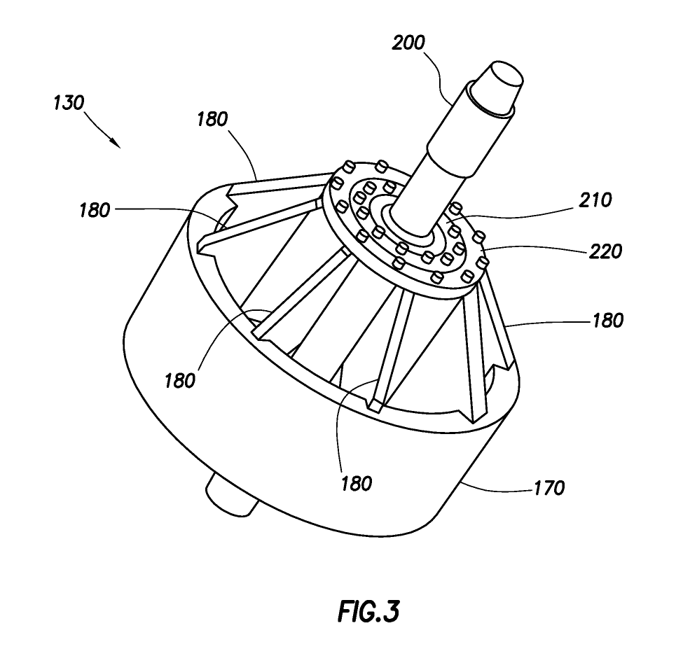

Referring now to FIGS. 3-6, the hang-off adapter 130 will be described in more detail in accordance with one embodiment of the present invention. As illustrated, the hang-off adapter 130 may include a tension ring interface 170, gusset plates 180, a bearing 190, and an inner body 200. In an embodiment, the hang-off adapter 130 further includes an inner housing 210 and an outer housing 220. In an embodiment, the hang-off adapter 130 may be designed in accordance with API 16F, Specification for Marine Drilling Riser Equipment, First Edition. A load test to about 1,100,000 pounds may be performed prior to use. The hang-off adapter 130 may be rated for at least about 1,000,000 pounds. It should be understood, however, that this rating could be increased or decreased to suit the user's needs. In an embodiment, the outer surfaces of the hang-off adapter 130 may be coated with a protective coating, such as an epoxy-resin coating. In an embodiment, the outer surfaces of the hang-off adapter 130, except for the tension ring interface 170, have an epoxy-resin coating. The inner housing 210 and outer housing 220 may be sealed, for example to retain lubrication and exclude sea water ingress.

The hang-off adapter 130 should transfer the weight of the riser 20 to the tensioning system 100 while allowing for relative rotation between the riser 20 and the tension ring 120. In accordance with embodiments of the present invention, the hang-off adapter 130 should allow the riser 20 to be hung off at any location by installation of the inner body 200 inline with the riser 20. As will be described in more detail below, the hang-off adapter 130 may be landed in the tension ring 120 without requiring lowering of a rig hand or additional components below the drill floor or other deck. Rather, the hang-off adapter 130 may be integrated into the riser 20 and lowered through the deck 90 until the tension ring interface 170 engages the tension ring 120, as best seen in FIG. 1. In this manner, the weight of the riser 20 may be transferred to the tensioning system 100. The bearing 190 should allow for relative rotation between the riser 20 and the tension ring 120 when the riser 20 is hanging off the tensioning system 100, in that the hang-off adapter 130 should rotatably couple the riser 20 to the tension ring 120.

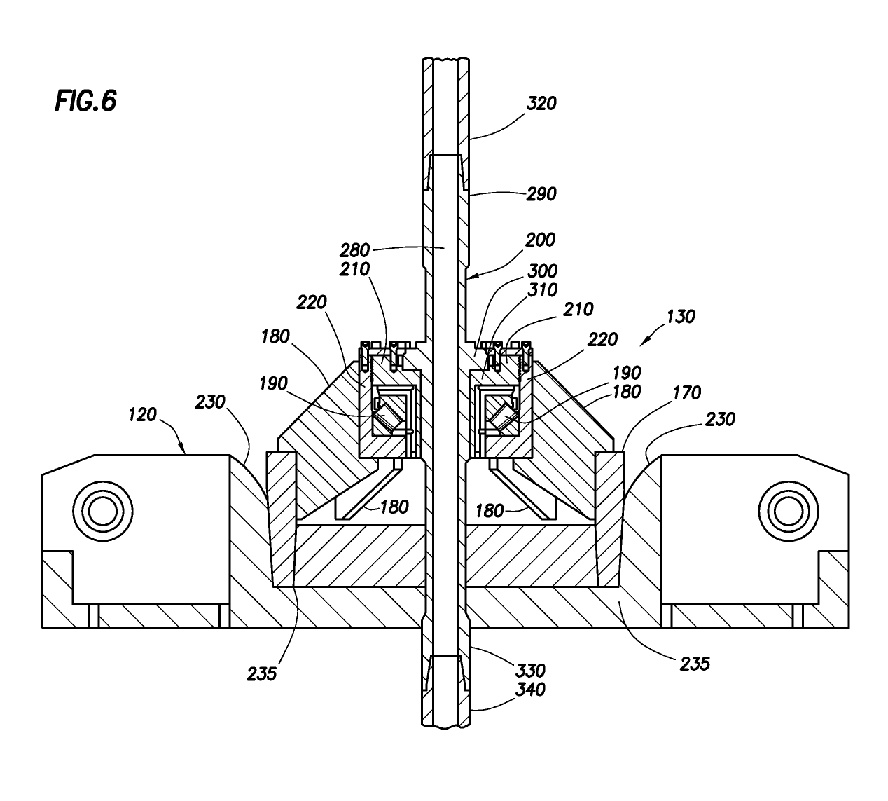

As illustrated by FIGS. 3-6, the tension ring interface 170 may be generally ring-shaped in accordance with embodiments of the present invention. The tension ring interface 130 should be configured and adapted to engage a landing 230 of the tension ring 120. The landing 230 of the tension ring may be grooved to receive the tension ring interface. As best seen in FIG. 6, the landing 230 of the tension ring 120 may have an upwardly facing inner shoulder 235 that receives the tension ring interface 170. The tension ring interface 170 may have an outer diameter suitable to mate with the tension ring 120. For example, the tension ring interface 170 may have an outer diameter in the range of from about 30 inches to about 60 inches. In an embodiment, the tension ring interface 170 has a diameter of about 58.5 inches. Larger or smaller diameters may also be used to suit the requirements of the tension ring 120 and the vessel's vertical access through the vessel's decks and rotary table.

The gusset plates 180 may be coupled between the tension ring interface 170 and the outer housing 220. In the illustrated embodiment, the hang-off adapter 130 includes eight gusset plates. The gusset plates 180 should generally transfer load from the outer housing 220 to the tension ring interface 170, in accordance with embodiments of the present invention. As illustrated, the gusset plates 180 may be mounted radially around the outer housing 220 and extend downwardly to the tension ring interface 170. In an embodiment, the gusset plates 180 may be welded to the outer housing 220 and the tension ring interface 170.

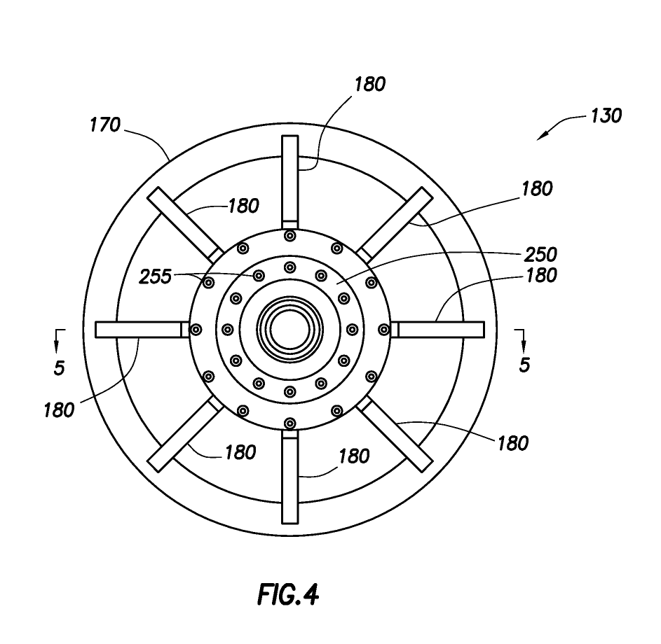

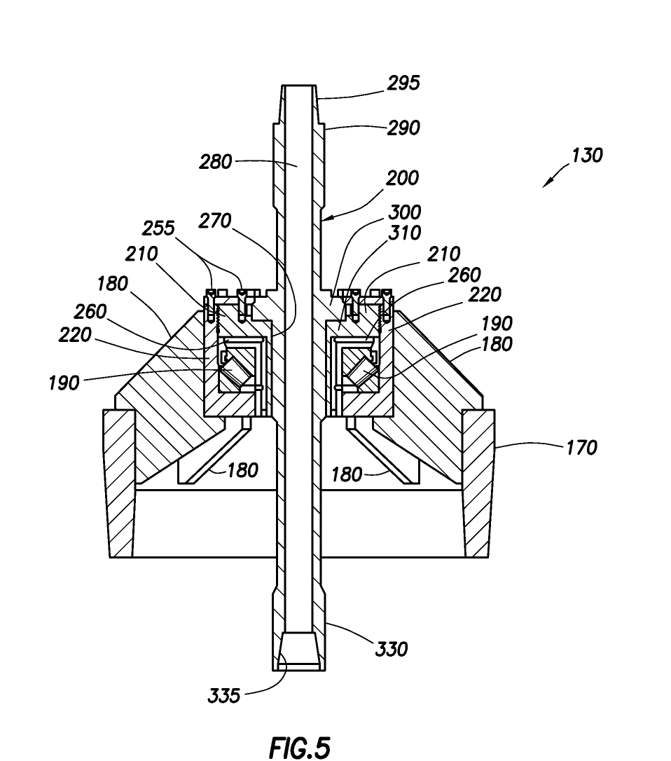

The bearing 190 may be enclosed within the inner housing 210 and the outer housing 220. The inner housing 210 may be rotatably coupled to the outer housing 220 by way the bearing 190. In an embodiment, as best seen in FIG. 3, an outer retainer ring 240 may be bolted to the top surface of the outer housing 220, and an inner retainer ring 250 may be coupled to the top surface of the inner housing 210. One or more bolts 255 may be used to couple the inner retainer ring 250 and the outer retainer ring 240 to the inner housing 210 and the outer housing 220, respectively. Any of a variety of suitable bearings may be used, including roller bearings and solid bearings. In an embodiment, the bearing 190 may be a self-aligning roller bearing. In an embodiment, the bearing 190 may be field replaceable. While not illustrated, seals may be incorporated within the hang-off adapter 130, depending, for example, on the type of bearing 190. For instance, one or more seals may be provided at the interface between the inner housing 210 and the outer housing 220. In addition, one or more lubricant passages 260 may be provided within the inner housing and/or outer housing for lubrication of the bearing, as best seen in FIGS. 4 and 5

The inner body 200 should be configured and adapted for attachment of the hang-off adapter 130 to the riser 20. In general, the inner body 200 may be rotatable about the longitudinal axis of the hang-off adapter 130. In the illustrated embodiment, the inner body 200 extends longitudinally through an opening 270 in the inner housing 210. In an embodiment, the inner body 200 may be a shaft generally tubular in shape with a passageway 280 extending therethrough in a direction of the longitudinal axis of the hang-off adapter 130. By way of example, the inner body 200 may be a joint of drill pipe. The inner body 200 may be fixed to the inner housing 210. The upper end 290 of the inner body 200 may extend upwardly and longitudinally from the opening 270 of the inner housing 210. A downwardly facing shoulder 300 between the upper end 290 and the lower end 330 of the inner body 200 may engage an upwardly facing shoulder 310 of the inner housing 210. In an embodiment, the downwardly facing shoulder 300 may be at the upper end 290 of the inner body 200. In an embodiment, the inner body 200 may be incorporated into the riser 200 between adjacent segments of the riser 200. The upper end 290 may be configured for attachment to the lower end of a first riser segment 320, as best seen in FIG. 6. In an embodiment, the upper end 290 may include threading 295 for coupling with the first riser segment 320. The lower end 330 of the inner body 200 may extend downwardly and longitudinally from the opening 270 of the inner housing 200. The lower end 330 may be configured for attachment to the upper end of a second riser segment 340, as best seen in FIG. 6. In an embodiment, the lower end 330 includes threading 335 for coupling with the second riser segment 340. The male threading 295 and female threading 335 may be the same as shown or may be reversed in accordance with embodiments of the present invention. The inner body 200 may be configured, for example, with 6⅝″ FH-EIS pin and box connections. The inner body 200, for example, may be configured with the same thread as the riser 20.

Referring now to FIGS. 1 and 6, a technique for installing a hang-off adapter 130 in a tension ring 120 will be described in accordance with one embodiment of the present invention. It should be understood that the present invention encompasses other suitable techniques for installing the hang-off adapter 130 in the tension ring 120. As previously mentioned, an embodiment of the hang-off adapter 130 may be used, for example, when desired to hang the riser 20 off the tension ring 120. The hang-off adapter 130 may be interconnected with the riser 20. For example, the inner body 200 may be coupled to the riser 20. Each of the upper end 290 of the inner body 200 and the lower end 330 of the inner body 20 may be coupled (e.g., threaded, bolted, screwed) to the riser 20, for example, between ends of adjacent segments of the riser. As seen in FIG. 5, the upper end 290 may be coupled to the first riser segment 320, and the lower end 330 may be coupled to the second riser segment 340. In an embodiment, when desired to install the hang-off adapter 130, the riser 20 may raised (or lowered) through the deck 90 (e.g., drill floor) until the segments of the riser 20 for attachment to the hang-off adapter 130 are in a desired position above the deck 90. In an alternative embodiment, the hang-off adapter 130 may be incorporated between segments of the riser 20 that were previously above the deck 90. After interconnection with the hang-off adapter 130, the riser 20 may then be lowered through the hole in the deck 90. The riser may be lowered until the hang-off adapter 130 has landed on the tension ring 120. When landed, the tension ring interface 170 should engage the inner landing 230 of the tension ring 120, for example. After the tension ring interface 170 engages the tension ring 120, the weight of the riser 20 can be released so that the weight of the riser 20 may be supported by the tensioning system 10 by way of the hang-off adapter 130. In this manner, the riser 20 can hang off the tension ring 120, as best seen in FIGS. 1 and 2. Because the hang-off adapter 120 allows for relative rotation of the riser 20 and the tension ring 120, the riser 20 should not fail due to stresses exerted from relative rotation of the floating platform 10 to the riser 210. After hang off, the equipment (e.g., draw works, top drive, hook, etc.) that previously supported the riser 20 can be removed to allow other equipment to be run through the hung-off riser 20 or other equipment to be installed on top of the riser 20 above the hang-off adapter 130. When desired to discontinue hang off, for example, the riser 20 can be raised, and the hang-off adapter 130 can be removed. In an embodiment, running of the riser 20 can then continue.

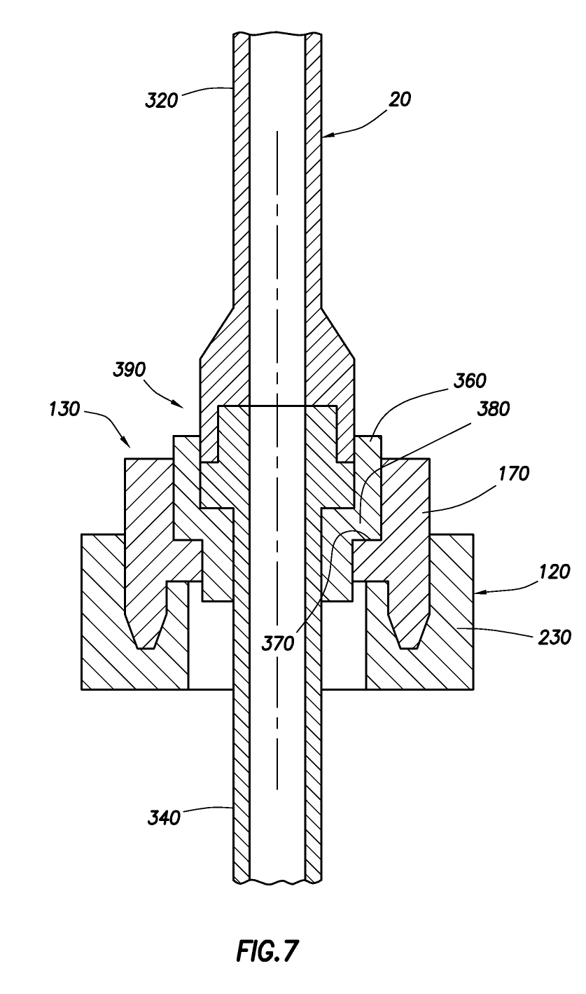

Referring now to FIG. 7, a hang-off adapter 130 is illustrated in accordance with another embodiment of the present invention. While the preceding discussion describes a hang-off adapter 130 that has been incorporated inline with a riser, the embodiment illustrated by FIG. 7 illustrates the hang-off adapter 130 coupled to the outer diameter of the riser 20. In the illustrated embodiment, the hang-off adapter 130 comprises a tension ring interface 170 and an inner bushing 360. The tension ring interface 170 should be configured and adapted to engage the landing 230 of the tension ring 120. In an embodiment, the tension ring interface 170 may be generally ring shaped. As illustrated, the tension ring interface 170 may have an inner shoulder 370 that is upwardly facing. In an embodiment, the inner shoulder 370 engages the inner bushing 360. For example, the inner bushing may include an outer shoulder 380 that is downward facing with the outer shoulder 380 engaging the inner shoulder 370 of the tension ring interface 170. In an embodiment, the inner bushing 360 is a split bushing. The inner bushing 360 may be coupled to the riser 20, for example the inner bushing 360 may be coupled to the riser 20 at a riser joint 390. The riser joint 390 may connect, for example, the first riser segment 320 and the second riser segment 340.

While the hang-off adapter 130 illustrated by FIG. 7 may be suited for a number of different uses, it may be particularly suited for hanging the riser 200 off the tension ring 120 in an emergency situation. For example, the hang-off adapter 130 may be suitable for use where circumstances prevent installation of a hang-off adapter 130 into the riser 20 at the drill floor prior to hang off This may be desirable, for example, when rig breakdown has occurred, and the riser 20 cannot be lifted. In an embodiment, the tension-ring interface 170 may be placed into the tension ring 120, for example, prior to running the riser 20 through the tension ring 120 or after larger objects (e.g., objects that cannot pass through the tension ring interface 130) have been passed through the tension ring 120. When desired to hang off the riser 20, the inner bushing 360 can be coupled to the outer diameter of the riser 20, and the riser 20 can be lowered until the inner bushing 360 engages the inner shoulder 370 of the tension ring interface 170. After the inner bushing 360 engages the tension ring interface 170, the weight of the riser 20 can be released so that the riser 20 may be supported by the tensioning system 100 by way of the hang-off adapter 130. In this manner, the riser 20 can hang off the tension ring 120. Because the hang-off adapter 130 allows for relative rotation of the riser 20 and the tension ring 120, the riser 20 should not fail due to stresses exerted from relative rotation of the floating platform 10 to the riser 20. After hang off, the equipment that previously supported the riser 20 can be removed to allow other equipment to be run through the hung-off riser or other equipment to be installed on top of the riser 20 above the hang-off adapter 130. When desired to discontinue hang off, for example, the inner bushing 360 can be removed. In an embodiment, running of the riser 20 can then continue.

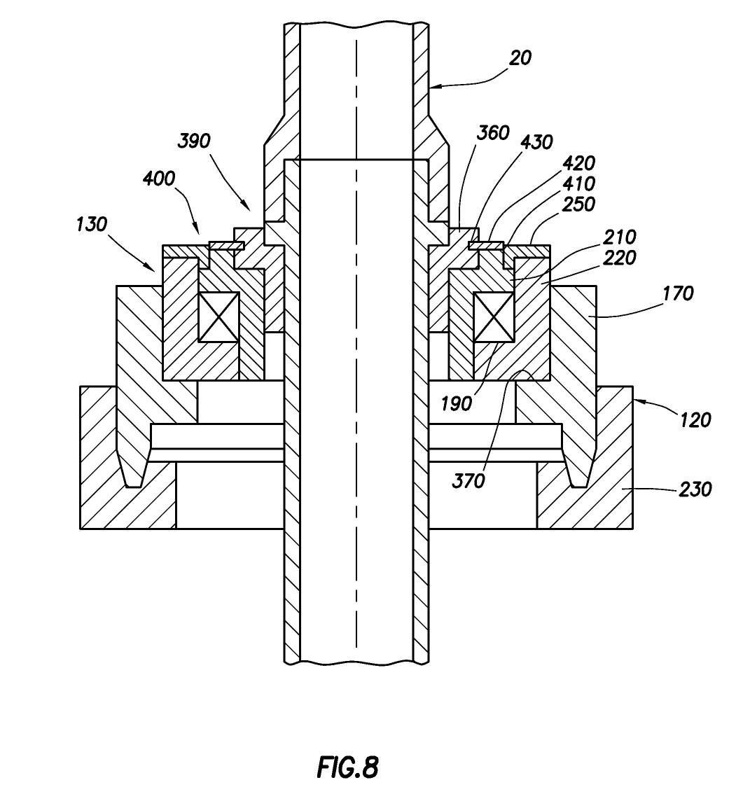

Referring now to FIG. 8, a hang-off adapter 130 is illustrated in accordance with another embodiment of the present invention. The illustrated embodiment is similar to the embodiment illustrated in FIG. 7 except that the hang-off adapter 130 further includes a rotating assembly 400. The rotating assembly 400 may include an inner bushing 360 and a bearing 190 enclosed within an inner housing 210 and an outer housing 220. In an embodiment, an inner housing keeper 250 may couple the inner and outer housings 210, 220. In an exemplary embodiment, the inner housing keeper 250 may be coupled to an upper surface of the outer housing 220 and an outer shoulder 410 of the inner housing 210 that is upwardly facing. As illustrated, the rotating assembly 400 may be coupled to the inner bushing 360. For example, a split bushing keeper 420 may couple the inner bushing 360 to the inner housing 210. In an exemplary embodiment, the split bushing keeper 420 may be coupled to an upper surface of the inner housing 210 with the split bushing keeper 420 secured in a slot 430 in the inner bushing 360.

While the hang-off adapter 130 illustrated by FIG. 8 may be suited for a number of different uses, it may be particularly suited for hanging the riser 200 off the tension ring 120 in an emergency situation. For example, the hang-off adapter 130 may be suitable for use where circumstances prevent installation of a hang-off adapter 130 into the riser 20 at the drill floor prior to hang off. This may be desirable, for example, when rig breakdown has occurred, and the riser 20 cannot be lifted. In an embodiment, the tension-ring interface 170 may be placed into the tension ring 120, for example, prior to running the riser 20 through the tension ring 120 or after larger objects (e.g., objects that cannot pass through the tension ring interface) have been passed through the tension ring. When desired to hang the riser 20 off the tension ring 120 with rotation, for example, the rotating assembly 400 may be coupled to the riser 20. The coupling may occur above the drill floor or other deck. In an embodiment, the split bushing 360 may be coupled to the outer diameter of the riser 20, for example, at riser joint 390. The riser 20 then can be lowered until the rotating assembly 400 engages the inner shoulder 370 of the tension ring interface 170 that is upwardly facing. As illustrated, the outer housing 220 may engage the inner shoulder 370. After the rotating assembly 400 engages the tension ring interface 170, the weight of the riser 20 can be released so that the riser 20 may be supported by the tensioning system 100 by way of the hang-off adapter 130. In this manner, the riser 20 can hang off the tension ring 120. Because the riser adapter 130 allows for relative rotation of the riser 20 with respect to the tension ring 120, the riser 20 should not fail due to stresses exerted from relative rotation of the floating platform 10 to the riser 20. After hang off, the equipment that previously supported the riser 20 can be removed to allow other equipment to be run through the hung-off riser 20 or other equipment to be installed on top of the riser 20 above the hang-off adapter 130. When desired to discontinue hang off, for example, the rotating assembly 400 can be removed. In an embodiment, running of the riser 20 can then continue.

Although the present invention and its advantages have been described in detail, it should be understood that various changes, substitutions and alterations may be made herein without departing from the spirit and scope of the invention as defined by the appended claims.

What is claimed is:

1. An apparatus comprising:
a hang-off adapter configured for attachment to a riser, the hang-off adapter comprising a tension ring interface configured to engage an inner landing of a tension ring, the tension ring interface being in the shape of a ring.

2. The apparatus of claim 1, wherein the tension ring interface has an outer diameter of about 30 inches to about 60 inches.

3. The apparatus of claim 1, further comprising an inner body configured to couple the hang-off adapter to the riser, wherein the hang-off adapter is rotatably coupled to the inner body, the inner body having a passageway extending therethough.

4. The apparatus of claim 3, wherein the inner body is a shaft that is generally tubular in shape.

5. The apparatus of claim 3, further comprising an inner housing enclosing at least a portion of the inner body.

6. The apparatus of claim 5, wherein the inner body extends longitudinally through an opening in the inner housing.

7. The apparatus of claim 5, wherein the inner body has a threaded upper end and a threaded lower end, the inner housing located between the threaded upper end and the threaded lower end.

8. The apparatus of claim 5, further comprising a bearing configured to allow relative rotation between the inner body and the tension ring interface.

9. The apparatus of claim 8, wherein the bearing comprises a roller bearing.

10. The apparatus of claim 8, further comprising an outer housing enclosing at least a portion of the bearing.

11. The apparatus of claim 10, further comprising gusset plates connecting the outer housing and the tension ring interface.

12. The apparatus of claim 11, wherein the gusset plates are mounted radially around the outer housing and extend downwardly from the outer housing to the tension ring interface.

13. The apparatus of claim 1, further comprising an inner bushing configured for attachment to an outer surface of the riser, the inner bushing configured for engagement with an upwardly facing inner shoulder of the tension ring interface.

14. The apparatus of claim 1 further comprising:
an inner bushing configured for attachment to an outer surface of the riser; and
a rotating assembly coupled to the inner bushing, the rotating assembly comprising a bearing enclosed within an inner housing and an outer housing, the outer housing configured to engage an upwardly facing inner shoulder of the tension ring interface.

15. The apparatus of claim 1, further comprising:
the riser coupled to the hang-off adapter; and
the tension ring, wherein the tension ring interface is seated in the inner landing of the tension ring.

16. An apparatus comprising:
an adapter for hanging a riser off a tension ring, the adapter comprising:
an inner body configured to couple the adapter to the riser, the inner body having an upper end, a lower end, and a passageway extending through the inner body;
an inner housing enclosing at least a portion of the inner body;
a bearing configured to allow axial rotation of the inner body;
an outer housing enclosing at least a portion of the bearing;
a tension ring interface configured to engage an inner landing of the tension ring; and
gusset plates connecting the outer housing and the tension ring interface.

17. The apparatus of claim 16, further comprising the riser, the riser comprising a first rise segment coupled to the upper end of the inner body and a second riser segment coupled to the lower end of the inner body.

18. The apparatus of claim 17, further comprising the tension ring, wherein the tension ring interface is seated in the inner landing of the tension ring.

19. A method for hanging a riser off a tension ring, the method comprising:
providing a hang-off adapter;
coupling the hang-off adapter to the riser;
seating a tension-ring interface of the hang-off adapter in a landing of the tension ring, the tension ring being coupled to a vessel by way of a tensioning system; and
releasing the weight of the riser so that the riser hangs off the tension ring, wherein riser is rotatable with respect to the tension ring.

20. The method of claim 19, further comprising lowering the riser with the hang-off adapter coupled thereto through a hole in a deck of a floating platform.
